(19) United States
(12) Patent Application Publication
(10) Pub. No.: US 2015/0341771 A1
(43) Pub. Date: Nov. 26, 2015

(54) HOTSPOT AGGREGATION METHOD AND DEVICE

(71) Applicants: BEIJING QIHOO TECHNOLOGY COMPANY LIMITED, Beijing (CN); QIZHI SOFTWARE BEIJING COMPANY LIMITED, Beijing (CN)

(72) Inventor: LIANG MA, BEIJING (CN)

(21) Appl. No.: 14/409,859

(22) PCT Filed: Jun. 9, 2013
(86) PCT No.: PCT/CN2013/077100

§ 371 Date: Dec. 19, 2014

(30) Foreign Application Priority Data
Jun. 20, 2012 (JP) 201210210038.2

(51) Int. Cl. H04W 8/00; H04L 12/24; G06F 17/30

(52) U.S. Cl. CPC H04W 8/005; G06F 17/30864; G06F 17/30194; H04L 41/12

(57) ABSTRACT

The present invention discloses a hotspot aggregation method and device. The method comprises: capturing network resources on the Internet; matching the network resources by means of a longest common subsequence (LCS) algorithm to acquire matching results; and generating hotspot phrases based on the matching results. By means of the technical solutions of the present invention, the operation and maintenance cost and the complexity of hotspot aggregation calculation can be reduced, the speed of hotspot aggregation is improved, real-time acquisition and real-time calculation can be achieved, and hotspot events can be discovered fast without substantial delay.

### FIELD OF THE INVENTION

The present invention relates to the technical field of computers, and in particular to a hotspot aggregation method and device.

### BACKGROUND OF THE INVENTION

In the prior art, a hotspot aggregation method may be applied to a bulletin board system (BBS), a blog and data such as web pages, news, microblogs, etc.

At present, each search engine provides products like hot list, e.g. hot search list of Baidu, hot list of SoSo and the like. In the prior art, there are basically two methods for hotspot aggregation:

I. periodically performing a statistical analysis on user query logs, segmenting query strings, extracting keywords, and sorting them according to the number of queries to obtain a list of hot words;

II. extracting center words from a web page's title or content, aggregating the center words and calculating out hotspot events.

In the method I, the hotspot events are calculated out on the basis of statistics, so the method has a certain lag and the hotspot events cannot be timely discovered. Moreover, both of the above two methods are based on a word segmentation technology and word segmention is based on a dictionary, but the word segmentation technology itself has a certain lag on discovery of new words, so that some new hot words and hot events cannot be timely discovered. Moreover, the effects of the above two methods excessively depend on the word segmentation technology, the dictionary needs to be maintained, and thus certain operation and maintenance cost is caused.

### SUMMARY OF THE INVENTION

In view of the above problems, the present invention provides a hotspot aggregation method and device for solving or at least partially solving or easing the above problems.

According to an aspect of the present invention, a hotspot aggregation method is provided, including: capturing network resources on the Internet; matching the network resources by means of a longest common subsequence (LCS) algorithm to obtain matching results; and generating hotspot phrases according to the matching results.

According to another aspect of the present invention, a hotspot aggregation device is provided, including: a network capturing module, configured to capture network resources on the Internet; a matching module, configured to match the network resources by means of an LCS algorithm to obtain matching results; and a generating module, configured to generate hotspot phrases according to the matching results.

According to a further aspect of the present invention, a computer program is provided, including computer-readable codes, wherein when the computer-readable codes are running on a server, the server executes the network hotspot aggregation method of any of claims 1-9.

According to a still further aspect of the present invention, a computer-readable medium is provided, in which the computer program of claim 19 is stored.

The present invention has the beneficial effects as follows:

The hotspot aggregation is performed for the network resources by the LCS algorithm, so that the problems of lag of hotspot word discovery and high dictionary maintenance and operation cost caused when hotspot aggregation is performed through a word segmentation technology in the prior art are solved, the operation and maintenance cost and the complexity of hotspot aggregating calculation can be reduced, the speed of hotspot aggregation is improved, real-time acquisition and real-time calculation can be achieved, and hotspot events can be discovered fast without delay basically.

The foregoing descriptions are merely summary of the technical solutions of the present invention. To understand the technical means of the present invention more clearly, it may be implemented according to the contents of the description. Moreover, to make the above-mentioned and other objectives, features and advantages of the present invention more obvious and easily understood, specific embodiments of the present invention will be listed below.

### BRIEF DESCRIPTION OF DRAWINGS

Various other advantages and benefits are clear for those of ordinary skill in the art by reading the following detailed description of preferred embodiments. The drawings are only intended to illustrate the preferred embodiments and not construed as limiting the present invention. Moreover, in all drawings, the same reference symbol represents the same component. In the drawings:

FIG. 1 schematically shows a flow diagram of a hotspot aggregation method according to an embodiment of the present invention;

FIG. 2 schematically shows a structural diagram of a hotspot aggregation device according to an embodiment of the present invention;

FIG. 3 schematically shows a detailed structural diagram of a hotspot aggregation device according to an embodiment of the present invention;

FIG. 4 schematically shows a block diagram of a server for executing the method of the present invention; and

FIG. 5 schematically shows a storage unit for keeping or carrying program codes for implementing the method of the present invention.

### DETAILED DESCRIPTION OF EMBODIMENTS

The present invention will be further described below in combination with figures and specific embodiments.

To solve the problems of lag of hotspot word discovery and high dictionary maintenance and operation cost caused when hotspot aggregation is performed through a word segmentation technology in the prior art, the present invention provides a hotspot aggregation method and device. According to the dictionary-free hotspot aggregation method of an embodiment of the present invention, subjects of web pages on the Internet are aggregated within a certain period by means of an LCS technology, so that hotspot events in this period may be quickly discovered. The present invention will be further described in detail below in combination with the figures and the embodiments. It should be understood that, the specific embodiments described herein are merely used for explaining the present invention, rather than limiting the present invention.

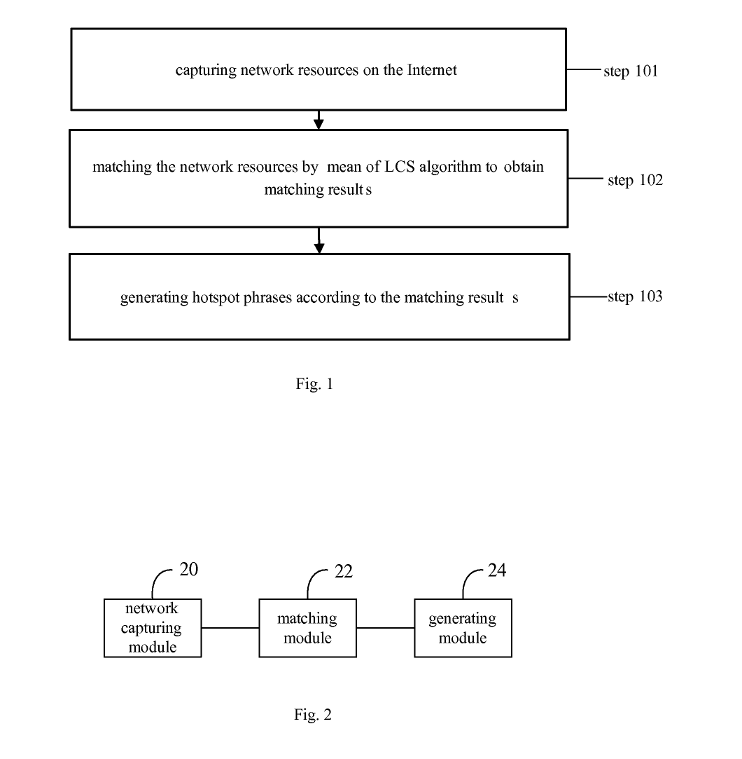

According to an embodiment of the present invention, a hotspot aggregation method is provided. FIG. 1 is a flow diagram of the hotspot aggregation method according to the embodiment of the present invention. As shown in FIG. 1, the hotspot aggregation method according to the embodiment of the present invention includes the following processes.

Step 101, capturing network resources on the Internet, wherein the network resources include web pages, posts, microblogs, blogs and the like.

Preferably, in practice, the network resources segmented by a predetermined time period or cycle need to be acquired from a file system, wherein the file system may be a distributed file system (moosefs) or a common file system. In step 101, network resources segmented by a certain segmentation period (namely the above predetermined time period) may be acquired from the moosefs. In practice, different segmentation period may be configured according to different kinds of the network resources (or different update speed of the network resources) to control the calculation period. For example, as the network resources of BBS are updated faster, the network resources of the BBS may be segmented by the hour (namely the segmentation period is one hour); and as the network resources of BLOG are updated slower, the related network resources of BLOG may be segmented by the day (namely the segmentation period is one day, 24 hours).

Moreover, after the network resources on the Internet are captured, the network resources may also be filtered.

Specifically, the processing of filtering the network resources specifically includes at least one of the following.

1. Filtering domain names (filter_host): filtering out the network resources with non-key domain names according to a preconfigured domain name list, so that junk data may be reduced.

2. Filtering according to a white list (filterblog_list blog): according to a preconfigured network white list, reserving the network resources corresponding to the network white list, e.g. reserving data of key blogs according to a blog white list.

3. Filtering according to view counts (filter_viewcount): filtering the network resources according to the view counts of web pages; e.g. according to the view counts of web pages or posts, filtering out the web pages or the posts of which the view counts is lower than a certain threshold and higher than another certain threshold. For example, the web pages or the posts of which the view counts is 0 or 1 and more than 10,000 are filtered out, wherein most of the web pages or the posts of which the view counts are more than 10,000 are wrongly captured or old posts.

4. Filtering according to reply counts (filter_replycount): filtering the network resources according to the reply counts of news, blogs or posts. For example, a certain post of which the reply count is more than 10,000 is filtered out, wherein most of such posts are wrongly captured or old posts.

5. Filtering according to publication time (filter_publictime): filtering the network resources according to the publication time of web pages, e.g. filtering out the posts one day before.

6. Filtering out useless prefix information such as section name, explanation and asking for help in a title (filter_title): namely, filtering out useless information in titles of network resources; and

7. Filtering out common words (filter_comm_word): filtering out the common words in the network resources, e.g. filtering out some common and meaningless words.

By filtering the network resources, most of interfering network resources and junk network resources in the network resources can be filtered out, in order to lay a good foundation for next matching.

Step 102, matching the network resources by means of an LCS algorithm to obtain matching results.

Specifically, in step 102, matching network resources by means of the LCS algorithm to obtain the matching results specifically includes the following processes: a matching relation between two characters on corresponding positions in two character strings is recorded in a matrix by means of the LCS algorithm, a matching sequence with the longest diagonal in the matrix is calculated, and the position of the longest matching substring (namely the above matching result) is acquired according to the position of the matching sequence in the matrix.

For example, the matching condition between two characters on each pair of corresponding positions respectively in the two character strings is recorded by a matrix by means of the LCS algorithm, and if the two characters are matched with each other, the matching condition is recorded as 1, otherwise, it is recorded as 0. Then, the sequence with the longest diagonal is solved, and the corresponding position of the sequence is the position of the longest matching substring. It should be noted that, LCS is a method for calculating the similarity of two character strings, wherein the longer the longest matching substring calculated by LCS is, the more similar the two character strings are. Therefore, the LCS may be used for aggregating similar subjects to achieve the purpose of discovering the same subjects.

Step 103, generating hotspot phrases based on the matching results.

Specifically, in step 103, the hotspot phrases are generated according to the position of the longest matching substring acquired in step 102 (namely the matching result).

To acquire more accurate hotspot phrases, in the embodiment of the present invention, a minimum number of network resources involved when generating a matching result by the matching by means of the LCS algorithm may be set, the matching results for each of which the number of the involved network resources is greater than the minimum number are acquired, and the hotspot phrases are generated based on the matching results. Of course, there are many dimensions for determining the hotspot phrases, e.g. the hotspot phrases may be ranked according to the quantity of the involved network resources, and the like.

Preferably, in the embodiment of the present invention, after the hotspot phrases are generated according to the matching results, identifiers of the network resources related to each hotspot phrase may also be acquired, and each hotspot phrase and the identifiers of the network resources related to the hotspot phrase are aggregated and stored as a hotspot group. The identifier of the network resource may be the link or uniform/universal resource locator (URL) of the network resource. Of course, in the embodiment of the present invention, the related network resources may also be directly stored.

To further aggregate the hotspot phrases, in the embodiment of the present invention, preferably, after the hotspot phrases are generated based on the matching results, the hotspot phrases may be further matched by means of the LCS algorithm to generate key phrases. Then, each key phrase, hotspot phrases corresponding to the key phrase and the identifiers of the network resources related to each hotspot phrase are stored as a hotspot group.

That is to say, the longest matching substrings calculated by means of the LCS algorithm are regarded as groups of phrases, key phrase is calculated out from a same group of phrases by using the LCS algorithm again, and the key phrase, all hotspot phrases corresponding to the key phrase and the identifiers of the corresponding network resources (websites, posts, blogs, microblogs and the like) are put in a hotspot as a hotspot group.

In practice, when each key phrase, the hotspot phrases corresponding to each key phrase and the identifiers of the network resources related to each hotspot phrase are stored as a hotspot group, the fields of the key phrase to be stored are shown in Table 1 and include hotspot group ID, key phrase, status for identifying whether the key phrase is valid or not, registration time, modification time and extended field.

TABLE 1

| Field Name | Type | Constraint | Explanation |
|---|---|---|---|
| group_id | int(11) | primary key | hotspot group id |
| keyword | varchar(255) | | key phrase |
| status | int(4) | | status |
| reg_time | datetime | | registration time |
| mod_time | timestamp | | modification time |
| ext | tinyint(4) | | extended field |

The fields of the hotspot phrase to be stored are as shown in Table 2, and include hotspot group ID, hotspot phrase, registration time, modification time and extended field. As shown in Table 1 and Table 2, the hotspot phrase and the key phrase are related by means of the “hotspot group ID” field.

TABLE 2

| Field Name | Type | Constraint | Explanation |
|---|---|---|---|
| group_id | int(11) | index | hotspot group id |
| wordstr | varchar(255) | unique index | hotspot phrase |
| reg_time | datetime | | registration time |
| mod_time | timestamp | | modification time |
| ext | tinyint(4) | | extended fields |

It should be noted that, in practice, it is possible that no key phrase can be got by aggregating due to few hotspot phrases in a same group, and thus there may be only hotspot phrases without key phrase in the hotspot group.

Preferably, after the above processes are executed, hotspot data in the stored hotspot group may be statistically analyzed, presented and/or queried. The hotspot data include key phrases, hotspot phrases corresponding to the key phrases and network resources related to the hotspot phrases.

Specifically, in practice, hotspot trend data shown in Table 3 also needs to be recorded, and include: hotspot group ID, date, related post number, view count, reply count, hot degree value, BBS post quality, BBS post quality score (pr_rank), registration time, modification time and extended field. According to Table 3, hotspots may be sorted and statistically analyzed within a period according to the hotspot trend. For example, the hotspots may be sorted according to the hot degree values, the related post numbers, the view counts and the reply counts, related phrases or posts in a hotspot group may be queried, and a hotspot trend graph may also be drawn to present the variation trend of the hotspots within the period.

TABLE 3

| Field Name | Type | Constraint | Explanation |
|---|---|---|---|
| group_id | int(11) | index | hotspot group id |
| Date | varchar(255) | index | date |
| num | int(11) | | related post number |
| viewcount | int(11) | | view count |
| replycount | int(11) | | reply count |
| hot_num | int(11) | | hot degree value |
| quality | int(11) | | quality |
| score | int(11) | | pr_rank |
| reg_time | Datetime | | registration time |
| mod_time | Timestamp | | modification time |
| ext | tinyint(4) | | extended field |

In conclusion, according to the dictionary-free hotspot aggregation method of the embodiment of the present invention, data needs to be captured first by the LCS to aggregate the hotspot subjects being discussed, then key phrases corresponding to the hotspots are calculated, and preferably, the hotspots may also be ranked according to the related post numbers, the view counts, the reply counts, the discussion counts and the like corresponding to the key phrases. According to the technical solution of the embodiment of the present invention, the word segmentation technology is not adopted, and the keywords are extracted, grouped and aggregated from the subjects by means of the LCS algorithm, so that some problems caused by the word segmentation, e.g. lag of new word discovery, high dictionary maintenance and operation cost and the like, are solved. Through the technical solution of the embodiment of the present invention, real-time acquisition and real-time calculation can be achieved, and hotspot events can be discovered fast.

It should be noted that, the hotspot aggregation method of the embodiment of the present invention may be applied to hotspot aggregation of BBS and BLOG, wherein data of BBS and BLOG is captured, the discussed subjects are aggregated to calculate out key phrases corresponding to hotspots, and the hotspots are ranked according to the related post numbers, view counts, reply counts, discussion counts and the like corresponding to the key phrases, so that hotspot events may be discovered fast. The technical solution of the embodiment of the present invention is not limited to application to BBS and BLOG data, but may be applied to other network resources such as web pages, news and mircoblogs.

By means of the above technical solution of the embodiment of the present invention, the hotspot aggregation is performed on the network resources by the LCS algorithm, so that the problems of lag of hotspot word discovery and high dictionary maintenance and operation cost caused when hotspot aggregation is performed through the word segmentation technology in the prior art are solved, the operation and maintenance cost and the calculation complexity can be reduced, the hotspot aggregation speed is improved, real-time acquisition and real-time calculation can be achieved, and hotspot events can be discovered fast without delay basically.

According to an embodiment of the present invention, a hotspot aggregation device is provided. FIG. 2 is a structural schematic diagram of the hotspot aggregation device of the embodiment of the present invention. As shown in FIG. 2, the hotspot aggregation device according to the embodiment of the present invention includes a network capturing module 20, a matching module 22 and a generating module 24. Each module of the embodiment of the present invention will be described in detail below.

The network capturing module 20 is configured to capture network resources on the Internet, wherein the network resources include web pages, posts, microblogs, blogs and the like.

Preferably, in practice, the network capturing module 20 needs to acquire the network resources segmented by a predetermined time period or cycle from a file system, wherein the file system may be a distributed file system (moosefs) or a common file system. The network capturing module 20 may acquire the network resources segmented by a certain segmentation period (namely the above predetermined time period) from moosefs. In practice, different segmentation period may be configured according to different kinds of network resources (or different update speed of the network resources) to control the calculation period. For example, as the network resources of BBS are updated faster, the network resources of the BBS may be segmented by the hour (namely the segmentation period is one hour); and as the network resources of BLOG are updated slower, the related network resources of BLOG may be segmented by the day (namely the segmentation period is one day, 24 hours).

Preferably, the above device further includes a filter module configured to filter the network resources after the network capturing module 20 captures the network resources on the Internet. Specifically, the filter module includes at least one of the following sub-modules.

1. A domain name filter sub-module configured for filtering according to domain name (filter_host): filtering out the network resources with non-key domain names according to a preconfigured domain name list, so that junk data may be reduced.

2. A white list filter sub-module configured for filtering according to a white list (filter_blog_list blog): according to a preconfigured network white list, reserving the network resources corresponding to the network white list, e.g. reserving data of key blogs according to a blog white list.

3. A view count filter sub-module configured for filtering according to view counts (filter_viewcount): filtering the network resources according to the view counts of web pages; e.g. according to the view counts of web pages or posts, filtering out the web pages or the posts of which the view counts is lower than a certain threshold and higher than another certain threshold. For example, the web pages or the posts of which the view counts is 0 or 1 and more than 10,000 are filtered out, wherein most of the web pages or the posts of which the view counts are more than 10,000 are wrongly captured or old posts.

4. A reply count filter sub-module configured for filtering according to reply counts (filter_replycount): filtering the network resources according to the reply counts of news, blogs or posts. For example, a certain post of which the reply counts is more than 10,000 is filtered out, wherein most of such posts are wrongly captured or old posts.

5. a publication time filter sub-module configured for filtering according to publication time (filter_publictime): filtering the network resources according to the publication time of web pages, e.g. filtering out the posts one day before.

6. a title filter sub-module configured to filter out useless prefix information such as section name, explanation and asking for help in titles (filter_title): namely, filtering out useless information in titles of network resources; and

7. A common word filter sub-module configured to filter out common words (filter_comm_word): filtering out the common words in the network resources, e.g. filtering out some common and meaningless words.

By filtering the network resources through the filter module, most of interfering network resources and junk network resources in the network resources can be filtered out, in order to lay a good foundation for next matching.

The matching module 22 is configured to match the network resources by means of an LCS algorithm to obtain matching results.

Specifically, the matching module 22 for matching the network resources by means of the LCS algorithm to obtain the matching results includes the following processes: the matching module 22 records a matching relation between two characters on corresponding positions in two character strings in a matrix by means of the LCS algorithm, calculates a matching sequence with the longest diagonal in the matrix, and acquires the position of the longest matching substring (namely the above matching result) according to the position of the matching sequence in the matrix.

For example, the matching condition between two characters on each pair of corresponding positions respectively in the two character strings is recorded by a matrix by means of the LCS algorithm, and if the two characters are matched with each other, the matching condition is recorded as 1, otherwise, it is recorded as 0. Then, the sequence with the longest diagonal is solved, and the corresponding position of the sequence is the position of the longest matching substring. It should be noted that, LCS is a method for calculating the similarity of two character strings, wherein the longer the longest matching substring calculated by the LCS is, the more similar the two character strings are. Therefore, the LCS may be used for aggregating similar subjects to achieve the purpose of discovering the same subjects.

The generating module 24 is configured to generate hotspot phrases based on the matching results.

Specifically, the generating module 24 generates the hotspot phrases according to the position of the longest matching substring (namely the matching result) acquired by the matching module 22.

Preferably, to acquire more accurate hotspot phrases, the generating module 24 is specifically configured to: set a minimum number of network resources involved when generating a matching result by the matching by means of the LCS algorithm, acquire the matching results for each of which the number of the involved network resources is greater than the minimum number, and generate the hotspot phrases according to the matching results.

Preferably, in the embodiment of the present invention, the hotspot aggregation device further includes:

a storage module, configured to acquire the identifiers of the network resources related to each hotspot phrase and store each hotspot phrase and the identifiers of the network resources related to the hotspot phrase as a hotspot group. The identifier of the network resource may be the link or uniform/universal resource locator (URL) of the network resource. Of course, in the embodiment of the present invention, the related network resources may also be directly stored.

To further aggregate the hotspot phrases, in the embodiment of the present invention, preferably, the matching module 22 is also configured to, after the hotspot phrases are generated based on the matching results, further match the hotspot phrases by means of the LCS algorithm to generate key phrases. Then, the storage module stores each key phrase, hotspot phrases corresponding to the key phrase and the identifiers of the network resources related to each hotspot phrase as a hotspot group.

That is to say, the matching module 22 regards the longest matching substrings calculated by means of the LCS algorithm as groups of phrases and calculates a key phrase from phrases in a same group by using the LCS algorithm again, and the key phrase, all hotspot phrases corresponding to the key phrases and the identifiers of the corresponding network resources (websites, posts, blogs, microblogs and the like) are put in a hotspot as a hotspot group.

In practice, when each key phrase, the hotspot phrases corresponding to each key phrase and the identifiers of the network resources related to each hotspot phrase are stored as a hotspot group, the fields of the key phrases to be stored are shown in Table 1 and include hotspot group ID, key phrases, status (for identifying whether the key phrase is valid or not), registration time, modification time and extended field.

TABLE 1

| Field Name | Type | Constraint | Explanation |
|---|---|---|---|
| group_id | int(11) | primary key | hotspot group id |
| keyword | varchar(255) | | key phrase |
| status | int(4) | | status |
| reg_time | datetime | | registration time |
| mod_time | timestamp | | modification time |
| ext | tinyint(4) | | extended field |

The fields of the hotspot phrase to be stored are shown in Table 2, and include hotspot group ID, hotspot phrase, registration time, modification time and extended field. As shown in Table 1 and Table 2, the hotspot phrase and the key phrase are related by means of the “hotspot group ID” field.

TABLE 2

| Field Name | Type | Constraint | Explanation |
|---|---|---|---|
| group_id | int(11) | index | hotspot group id |
| wordstr | varchar(255) | unique index | hotspot phrase |
| reg_time | datetime | | registration time |
| mod_time | timestamp | | modification time |
| ext | tinyint(4) | | extended fields |

It should be noted that, in practice, it is possible that no key phrase can be got by aggregating due to few hotspot phrases in a same group, and thus there may be only hotspot phrases without key phrase in the hotspot group.

According to the embodiment of the present invention, the hotspot aggregation device further includes: a statistical analysis module, configured to statistically analyze, present and/or query hotspot data in the stored hotspot group.

Specifically, after the above processes are executed, the statistical analysis module may statistically analyze, present and/or query the hotspot data in the stored hotspot group. The hotspot data includes key phrases, hotspot phrases corresponding to the key phrases and network resources related to the hotspot phrases.

Specifically, in practice, hotspot trend data shown in Table 3 also needs to be recorded, and includes: hotspot group ID, date, related post number, view count, reply count, hot degree value, BBS post quality, BBS post quality score (pr_rank), registration time, modification time and extended field. According to Table 3, hotspots may be sorted and statistically analyzed within a period according to the hotspot trend. For example, the hotspots may be sorted according to the hot degree values, the related post numbers, the view counts and the reply counts, related phrases or posts in a hotspot group may be queried, and a hotspot trend graph may also be drawn to present the variation trend of the hotspots within the period.

TABLE 3

| Field Name | Type | Constraint | Explanation |
|---|---|---|---|
| group_id | int(11) | index | hotspot group id |
| Date | varchar(255) | index | date |
| num | int(11) | | related post number |
| viewcount | int(11) | | view count |
| replycount | int(11) | | reply count |
| hot_num | int(11) | | hot degree value |
| quality | int(11) | | quality |
| score | int(11) | | pr_rank |
| reg_time | Datetime | | registration time |
| mod_time | Timestamp | | modification time |
| ext | tinyint(4) | | extended field |

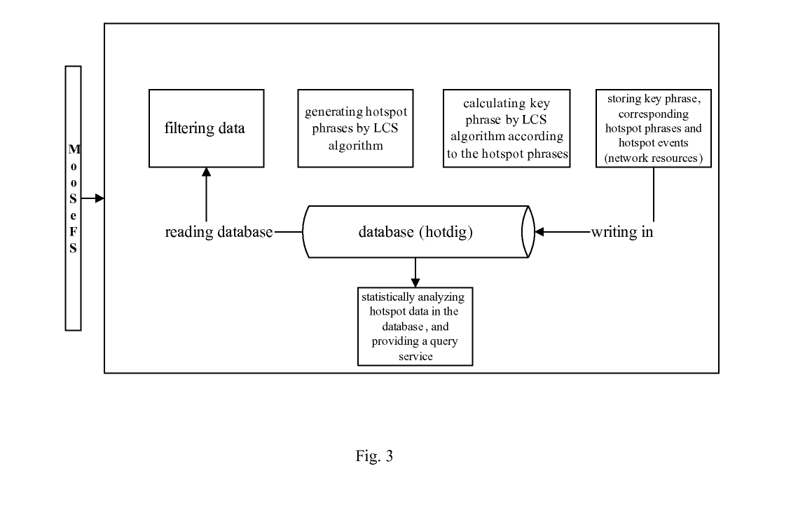

FIG. 3 is a detailed structural schematic diagram of a hotspot aggregation device of the embodiment of the present invention. As shown in FIG. 3, according to the dictionary-free hotspot aggregation device of the embodiment of the present invention, the network resources in the moosefs are segmented through configuration (BLOG is segmented by the day, and BBS is segmented by the hour), then data is filtered, the filtered data is captured through the LCS algorithm, the discussed hotspot subjects are aggregated, and hotspot phrases are calculated out. Then, the hotspot phrases are grouped and aggregated, and corresponding key phrases are calculated out. Finally, the calculated hotspot phrases, key phrases and hotspot events (above network resources) are stored into a database (hotding). Preferably, the data stored in the hotding may also be statistically analyzed, e.g. the hotspots may be ranked according to the related post numbers, view counts, reply counts, discussion counts and the like corresponding to the key phrases. According to the technical solution of the embodiment of the present invention, the word segmentation technology is not adopted, and the keywords are extracted, grouped and aggregated from the subjects by means of the LCS algorithm, so that some problems caused by the word segmentation, e.g. lag of new word discovery, high dictionary maintenance and operation cost and the like, are solved. Through the technical solution of the embodiment of the present invention, real-time acquisition and real-time calculation can be achieved, and hotspot events can be discovered fast.

It should be noted that, the hotspot aggregation device of the embodiment of the present invention may be applied to hotspot aggregation of BBS and BLOG, wherein data of BBS and BLOG is captured, the discussed subjects are aggregated to calculate out key phrases corresponding to hotspots, and the hotspots are ranked according to the related post numbers, view counts, reply counts, discussion counts and the like corresponding to the key phrases, so that hotspot events may be discovered fast. The technical solution of the embodiment of the present invention is not only applied to BBS and BLOG data, but also may applied to other network resources such as web pages, news and microblogs.

By means of the above technical solution of the embodiment of the present invention, the hotspots of the network resources are aggregated by the LCS algorithm, so that the problems of hotspot word discovery delay and high dictionary maintenance and operation cost caused when hotspot aggregation is performed through the word segmentation technology in the prior art are solved, the operation and maintenance cost and the calculation complexity can be reduced, the hotspot aggregation speed is improved, real-time acquisition and real-time calculation can be achieved, and hotspot events can be discovered fast without delay basically.

Each component embodiment of the present invention may be implemented by hardware, software modules running in one or more processors or a combination of hardware and software modules. Those skilled in the art should understand that, some or all functions of some or all components in the hotspot aggregating device according to the embodiment of the present invention may be realized by a microprocessor or a digital signal processor (DSP) in practice. The present invention may also be implemented as part of or all of equipment or device programs (e.g. computer programs and computer program products) for executing the method described herein. Based on this implementation, the programs of the present invention may be stored in a computer-readable medium, or may have a form of one or multiple signals. Such signals may be obtained by downloading from Internet websites, provided on carrier signals or provided in any other form.

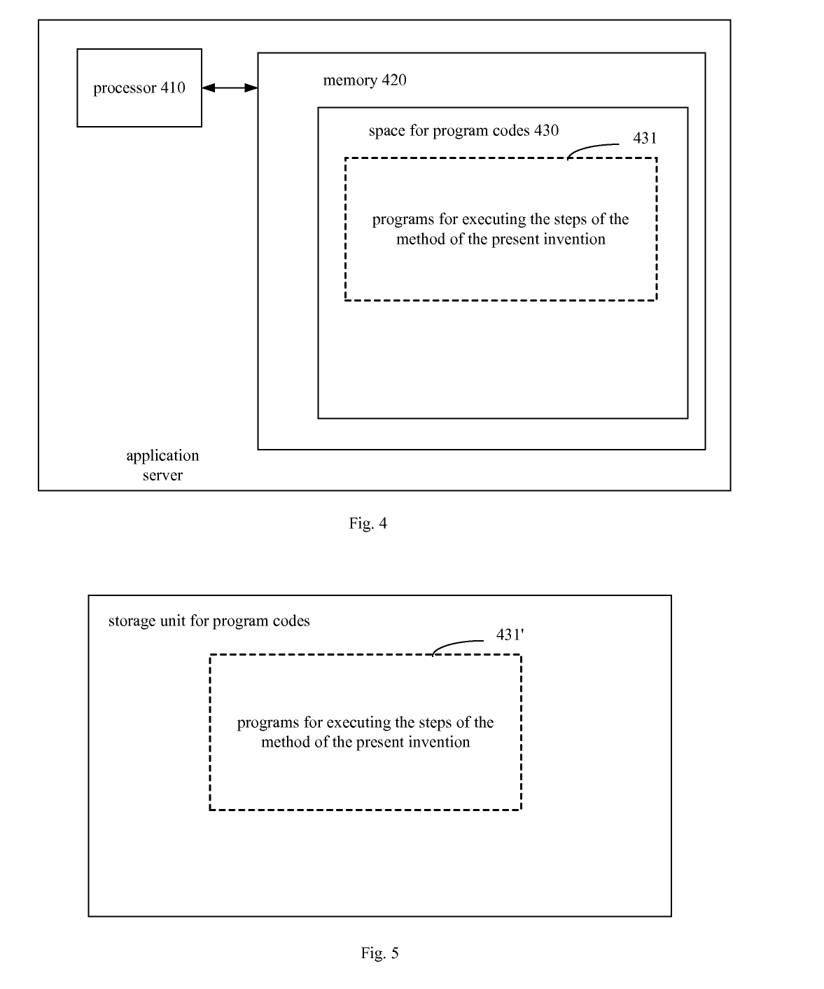

For example, FIG. 4 shows a server capable of implementing the hotspot aggregation method according to the present invention, e.g. an application server. The server traditionally includes a processor 410 and computer program products or computer-readable media in the form of a memory 420. The memory 420 may be an electronic memory such as a flash memory, an EEPROM (electrically erasable programmable read-only memory), an EPROM, a hard disk, an ROM (read-only memory) or the like. The memory 420 has a storage space 430 for program codes 431 for executing any method step in the above-mentioned method. For example, the storage space 430 for the program codes may include the program codes 431 for implementing all the steps of the above method. These program codes may be read from or written into one or more computer program products. These computer program products include program code carriers such as a hard disk, a compact disk (CD), a storage card or a soft disk. Such computer program products are generally portable or fixed storage units as mentioned in FIG. 5. The storage unit may be provided with a storage section, a storage space and the like arranged like the server 420 in the server of FIG. 4. The program codes may be compressed in an appropriate form. Generally, the storage unit includes computer-readable codes 431′, namely codes which may be read by the processor 410, and when these codes are running in the server, the server executes each step in the above-described method.

“An embodiment”, “embodiment” or “one or more embodiments” described above indicate that specific features, structures or characteristics described in combination with the embodiments are included in at least one embodiment of the present invention. Moreover, please note that the term example “in an embodiment” herein may not be the same embodiment.

A large amount of specific details are described in the description provided herein. However, it could be understood that, the embodiments of the present invention may be practiced in the absence of these specific details. In some examples, well-known methods, structures and technologies are not described in detail, so that the description won't be vaguely understood.

It should be noted that the above-mentioned embodiments are used for describing the present invention, rather than limiting the present invention, and alternative embodiments may be designed by those skilled in the art without departing from the scope of the appended claims. The claims should not be limited to any reference signs between brackets. The term “include” does not exclude components or steps which are not listed in the claims. “A” or “one” ahead of a component does not exclude multiple such components. The present invention may be implemented by means of hardware including a plurality of different components and by means of an appropriately programmed computer. In the claims listing a plurality of devices, a plurality of these devices may be specifically embodied by the same hardware item. Terms “first, second, third and the like” do not indicate any sequence, and these terms may be interpreted as names.

Moreover, it should also be noted that, the language used in the description is selected mainly for the purposes of readability and teaching, rather than explaining or limiting the subjects of the present invention. Accordingly, many modifications and alterations are obvious to those of ordinary skill in the art without departing from the scope and spirit of the appended claims. For the scope of the present invention, the disclosure of the present invention is illustrative rather than limiting, and the scope of the present invention is defined by the appended claims.

1. A network hotspot aggregation method, comprising:
capturing, by at least one processor, network resources on the Internet;
matching, by the at least one processor, the network resources using a longest common subsequence (LCS) algorithm to obtain matching results; and
generating, by the at least one processor, hotspot phrases based on the matching results.

2. The method of claim 1, wherein generating of hotspot phrases based on the matching results comprises:
setting a minimum number of network resources involved when generating a matching result by the matching using the LCS algorithm;
acquiring the matching results when the number of the involved network resources is greater than the minimum number, and generating the hotspot phrases based on the acquired matching results.

3. The method of claim 1, wherein capturing network resources on the Internet comprises:
acquiring from a distributed file system the network resources segmented by a predetermined time period.

4. The method of claim 1, wherein after capturing network resources on the Internet, the method further comprises:
filtering the network resources.

5. The method of claim 4, wherein filtering the network resources comprises at least one of:
filtering out network resources with specified domain names according to a preconfigured domain name list;
according to a preconfigured network white list, reserving network resources corresponding to the network white list;
filtering the network resources according to view counts of web pages;
filtering the network resources according to publication time of web pages;
filtering the network resources according to reply counts of news, blogs or posts;
filtering out useless information in titles of the network resources; and
filtering out common words in the network resources.

6. The method of claim 1, wherein after generating the hotspot phrases based on the matching results, the method further comprises:
acquiring identifiers of network resources related to each hotspot phrase, and aggregating and storing each hotspot phrase and the identifiers of the network resources related to the hotspot phrase as a hotspot group.

7. The method of claim 6, wherein after generating the hotspot phrases based on the matching results, the method further comprises:
further matching the hotspot phrases using the LCS algorithm to generate key phrases wherein storing each hotspot phrase and the identifiers of the network resources related to the hotspot phrase as a hotspot group comprises:
storing each key phrase, hotspot phrases corresponding to the key phrase and the identifiers of network resources related to the hotspot phrases as a hotspot group.

8. The method of claim 1, wherein matching the network resources using of the LCS algorithm to obtain the matching results comprises:
recording in a matrix a matching relation between two characters on corresponding positions respectively in two character strings using the LCS algorithm, calculating a matching sequence with a longest diagonal in the matrix, and acquiring a position of a longest matching substring according to a position of the matching sequence in the matrix,
wherein generating the hotspot phrases based on the matching results comprises:
generating the hotspot phrases according to the position of the longest matching substring.

9. The method of claim 6, wherein after the hotspot group is stored, the method further comprises:
statistically analyzing, presenting and/or querying hotspot data in the stored hotspot group.

10. A hotspot aggregation device, comprising:
at least one processor to execute a plurality of modules comprising:
a network capturing module to capture network resources on the Internet;
a matching module to match the network resources using a longest common subsequence (LCS) algorithm to obtain matching results; and
a generating module to generate hotspot phrases based on the matching results.

11. The device of claim 10, wherein the generating module:
sets a minimum number of network resources involved when generating a matching result by the matching using the LCS algorithm; and
acquires the matching results when the number of the involved network resources is greater than the minimum number, and generates the hotspot phrases based on the acquired matching results.

12. The device of claim 10, wherein the network capturing module acquires from a distributed file system the network resources segmented by a predetermined time period.

13. The device of claim 10, further comprising:
a filter module to filter the network resources after the network capturing module captures the network resources on the Internet.

14. The device of claim 13, wherein the filter module comprises at least one of the following sub-modules:
a domain name filter sub-module to filter out network resources with specified domain names according to a preconfigured domain name list;
a white list filter sub-module to, according to a preconfigured network white list, reserve network resources corresponding to the network white list;
a view count filter sub-module to filter the network resources according to view counts of web pages;
a publication time filter sub-module to filter the network resources according to publication time of web pages;
a reply count filter sub-module to filter the network resources according to reply counts of news, blogs or posts;
a title filter sub-module to filter out useless information in titles of the network resources; and
a common word filter sub-module to filter out common words in the network resources.

15. The device of claim 10, further comprising:
a storage module to acquire identifiers of network resources related to each hotspot phrase and store each hotspot phrase and the identifiers of the network resources related to the hotspot phrase as a hotspot group.

16. The device of claim 15, wherein the matching module matches the hotspot phrases using the LCS algorithm to generate key phrases; and
wherein the storage module stores each key phrase, hotspot phrases corresponding to the key phrase and the identifiers of network resources related to the hotspot phrase as a hotspot group.

17. The device of claim 10, wherein the matching module records in a matrix a matching relation between two characters on corresponding positions in two character strings using the LCS algorithm, calculate a matching sequence with a longest diagonal in the matrix, and acquires a position of the longest matching substring according to a position of the matching sequence in the matrix; and
wherein the generating module generates the hotspot phrases according to the position of the longest matching substring.

18. The device of claim 15, further comprising:
a statistical analysis module to statistically analyze, present and/or query hotspot data in the stored hotspot group.

19-20. (canceled)

21. A non-transitory computer readable medium having instructions stored thereon that, when executed by at least one processor, cause the at least one processor to perform network hotspot aggregation operations, comprising:
capturing network resources on the Internet;
matching the network resources using a longest common subsequence (LCS) algorithm to obtain matching results; and
generating hotspot phrases based on the matching results.
